(19) United States
(12) Patent Application Publication
(10) Pub. No.: US 2014/0005052 A1
(43) Pub. Date: Jan. 2, 2014

(54) PHYTOSANITARY COMPOSITIONS AND SPRAYING PRODUCTS IN THE FORM OF MICROEMULSIONS

(71) Applicant: Edmundo Blumel, Buenos Aires (AR)

(72) Inventor: Edmundo Blumel, Buenos Aires (AR)

(73) Assignee: Red Surcos S.A., Buenos Aires (AR)

(21) Appl. No.: 13/535,695

(22) Filed: Jun. 28, 2012

(51) Int. Cl. A01N 37/10; A01P 15/00; A01P 7/04; A01P 3/00; A01N 39/02; A01P 13/00

(52) U.S. Cl. 504/323; 504/324; 514/568; 514/571

(57) ABSTRACT

Phytosanitary compositions in the form of microemulsions with active ingredients formulated in their acid form, with compositions comprising a combination of an active ingredient or mixtures thereof in their acid form, a non-ionic surfactant, an anionic surfactant, a polar cosolvent, and water.

### BACKGROUND OF THE INVENTION

1. Field of the Invention

This invention relates to products and active ingredients applied in the control of plagues, preferably in agriculture and the industry of plant cultures, and more particularly it relates to phytosanitary compositions, herbicides, mixtures of herbicides in the form of microemulsions, comprising one or more active ingredients in their acid form, for their application as herbicides, insecticides, fungicides, biocides and the like.

2. Description of the Prior Art

Phytosanitary products and agrochemicals used in the agricultural production area are very well known. These products contain active ingredients selected for acting on the plague that is affecting production and they should be formulated with carriers which may aid their application and effectiveness. Thus, the best formulation thereof is sought in order to take advantage of their active ingredients as much as possible transferring them to the plant with the least possible losses either due to lack of adherence to the plant, rain washing, winds, or other physical losses. The best ways of application of the majority of these products to crops have shown to be the emulsifiable concentrates (EC) in which they are presented and even when conventional emulsions have had acceptable behavior it has been shown that microemulsions, with a drop size below 0.4 μm in the spray mixture, get much better results.

A microemulsion is a isotropic and stable liquid mixture containing an oil and/or organic solvent, water and surfactants wherein products such as herbicides, insecticides, etc, are combined for being applied on crops, by any convenient way, for instance, spraying. Thus, the two immiscible phases, water and oil, make up a system together with the surfactant. Microemulsion is spontaneously formed by simply mixing without requiring high cutting forces in such mixing process as its Gibbs free energy is negative.

In fact, microemulsions differ from emulsions, in that microemulsions are systems having one phase closely related to micellar solutions, therefore, a microemulsion may be defined as a system of water, oil and/or organic solvent and surfactant, being a one-phase solution and, at the same time, is in thermodynamic equilibrium (same pressure and temperature). The most characteristic feature of microemulsions is such thermodynamic stability. While an emulsion will always be split up over time, a microemulsion is infinitely stable, provided that temperature is maintained within a range characteristic of the formulation.

Correctly formulated microemulsions, that is, those having a high solubility capacity both in water and oil, give very low interfacial tensions. The microemulsions also show a very high capacity for penetrating polar and non-polar material. Penetration is particularly important in wood and heterogeneous materials consisting of polar and non-polar microdomains. Compared to emulsions which generate emulsifiable concentrates (EC), microemulsions have an extremely great interfacial area between aqueous and oily domains. Any solid surface in contact with a microemulsion is simultaneously in contact with both aqueous and organic phases.

For the preparation of commercial herbicide solutions of active ingredients that are acid, conventional formulations make viable the solubility of the active ingredient in the water of the formula and in the water of the spray mixture, salifying the active ingredient. This is the way it is performed, for example, with active ingredients such as acids of herbicides known as 24D and Dicamba and obtain soluble concentrates (SL). Other resource for their use is the esterification of the active ingredient such that an emulsifiable concentrate (EC) may be generated, for example 24D ester. Unfortunately, activity of the active ingredient is affected by salification, and in a less grade by esterification, reducing their active power/effectiveness.

In order to take advantage of the acid forms of several active ingredients, it is well known the use of herbicide compounds, in their acid forms, combined with surfactants to form microemulsion-forming-concentrates, also known as “MFCs”. The MFCs are generally composed of a selected herbicide compound in acid form with a surfactant, for example, from about 10 to about 40 parts by weight herbicide compound in acid form, and about 60 to about 90 parts by weight surfactant. The MFCs preferably do not include any organic solvent and they are relatively stable compositions that are designed to be mixed or diluted with water to form a microemulsion for agrochemical application. In other words, these MFCs are not commercially available in microemulsion forms and are concentrates which are relatively stable, that is, they are not stable enough, either a cool and/or hot temperatures, so as to satisfy the CIPAC/FAO standards.

Then, it would be very convenient to be able to achieve microemulsions that remain stable either in their commercial presentation and the spray mixture to be sprayed over the plants, which microemulsion increases the active power of the active ingredient/s being present, without thereby affecting the solubilization capacity in the water of the commercial product and, above all, in the water of the spray mixture.

### SUMMARY OF THE INVENTION

It is therefore an object of this invention to provide for new herbicide compositions and any other phytosanitary product which acid ingredients do not need to be salified, and that may be solubilized into special surfactants for being then microemulsionated with the water of the formula and, subsequently, in the spray mixture continue keeping their features as microemulsion.

It is still another object of this invention the formulation of microemulsions with active ingredients directly in their acid form.

It is still another object of this invention to provide for herbicide compositions and/or other physotanitary products in the form of microemulsions with active ingredients directly formulated in their acid form for not altering the activity of such active ingredients, wherein compositions comprise:

between 2% and 40% of at least one active ingredient or mixtures thereof in their acid form;

between 5% and 70% of at least one non-ionic surfactant;

between 0% and 50% of at least one anionic surfactant;

between 5% and 50% of a polar cosolvent, and

between 5% and 30% of water, with all the percentages being expressed in w/v.

### DETAILED DESCRIPTION OF THE INVENTION

Now referring in detail to compositions of the invention it can be noted that the invention provides for a new phytosanitary composition and/or herbicide in the form of a stable microemulsion, such that the formulation of active ingredients may be directly obtained in their acid forms, but keeping the solubilization power thereof in the water of the formula and, mainly, in the water of the spray mixture.

In the formulation of herbicides, it is known the use of 2,4-D dichlorophenoxyacetic acid as active ingredient consisting of an auxine hormone systemic herbicide of great use within the market and among its uses the following can be mentioned: control of weeds and bushes along fences and roads, conifer opening and haymaking of pastures among others.

3,6-dichloro-2-metoxibenzoic acid, known as Dicamba, is often used for the formulation of physotanitary products, which is an herbicide that is used for the annual and perennial control of weeds in the harvest of roses and the control of weeds and ferns in pastures.

As explained above, in traditional formulations of phytosanitary products, more particularly using the aforementioned acid herbicides, a salification of such acids is performed so as to achieve the correct viabilization of the solubility of the active ingredient in the water of the formula and of the dispersion mixture, such as it is the case of amine salts. Another way of achieving the task is by means of performing an esterification, obtaining an emulsifiable concentrate such as the esters of such acids. As it was also explained above, active ingredients, in their acid form, have been formulated with surfactants, in relatively stable concentrates, capable of being dissolved in water to form a final sprayable product.

According to the present invention, a novel formulation or composition, including an active ingredient in the acid form, comprises a microemulsion that is capable of being dissolved in water to form a final spraying product that is stable both, in their concentrate microemulsion commercial presentation as well as in their dissolved microemulsion spraying form. Thus, the composition has a liphofilic part, provided by the active ingredient and organic solvent, either ketones and methanol, depending on whether 2,4-D dichlorophenoxyacetic acid or 3,6-dichloro-2-metoxibenzoic acid is employed, and an hydrophilic part comprised of water in the formulation. These parts are combined with the surfactants and emulsifiers to obtain the microemulsion.

Distinct from the concentrates know in the art, the microemulsions of the present invention, in addition to the novel combination of components, includes water and organic solvents. This result in a shelf stable microemulsion capable of being dissolved in water to form a sprayable microemulsion.

The object of this invention is to be able to obtain the advantages provided by a substance in the form of a microemulsion, in addition to provide such herbicide in their acid form which is the more active/effective and in addition to an esteric benefit facilitating translocation of these products of systemic nature, as the acid forms have lower molecular size than salified forms. In connection with microemulsion, advantages are achieved such as presenting capacity of penetration in polar and non-polar materials, obtaining a extremely great interfacial area between aqueous and oily domains in such a way that any surface in contact with a microemulsion is simultaneously in contact with such aqueous and organic phases, and mainly, providing the substance with a high capacity of solubility both in water and in oil. As mentioned, in addition to these advantages provided by the form of microemulsion in which such formulation is present, the advantages of providing such herbicide in the acid form is added, being this much more active than the aforementioned salts or esters. One of the advantages is the esteric effect due to the fact that the size of the molecule of the acid is smaller that that of the salt or ester, which is significantly important in systemic products. Another advantage that may be mentioned is that the lower pH of the acid formulation causes the herbicide to have a higher positive charge (+) that provides a great electric affinity with the foliar mass and leaf area which is essentially negative (−). Thus, the adherence and absorption of the herbicide is enhanced. As a result, due to its effectiveness, the quantity of active ingredient to be used is notably reduced (approximately in a factor 2), thus it reduces the environmental impact.

In addition to the advantages already mentioned, it could be added that these product are not affected by the hardness of the water of the spray mixture, as the active ingredient in the commercial product is an acid, and its volatility is lower than any of the existing commercial presentations.

In order to achieve the formulation of active ingredients in their acid form, the solubilisation of such acid active ingredients into the desired surfactants is performed thanks to the use of one or more non-ionic surfactants, preferably ethoxylated fatty alcohols, ethoxylated fatty amines and/or triestyril phenol ethoxilates and, in some embodiment of the invention also one or more anionic surfactants, preferably calcium dodecylbenzenesulfonate. Then, such surfactants are microemulsionated with the water of the formula. In order not to alter the activity of the active ingredients, the compositions of such herbicide should preferably range between values of between 2% and 40% w/v, of at least one active ingredient or mixtures thereof in their acid form.

Non-ionic surfactant/s, may be selected from surfactants such as ethoxylated fatty alcohol/s or ethoxylated fatty amines or tristyrilphenol ethoxylates, should be present between 5% and 70% and, for one of the active ingredients, namely Dicamba acid, anionic surfactant/s, such as calcium dodecylbenzenesulfonate, should be present between 2% and 50% w/v. It is also necessary the use of a cosolvent which should be provided to the composition between 5% and 50% w/v. Among the possible cosolvents to be used, methyl alcohol, ketones and cyclohexanones, or other polar solvents may be mentioned. An anti-crystallization agent, such as amides from fatty acids, as well as N,N-dimethyloctanamide/decanamide, commercially available under the tradename Genagen 4296 also may be employed in the formulations. The rest of the composition is water which constitutes the continuous phase of the formulation, bearing a rest between 5% and 30% w/v.

Generally, the invention provides phytosanitary compositions in the form of microemulsions with active ingredients formulated in their acid form in order not to alter the activity of such active ingredients. The compositions comprise:

between about 2% and about 40% of at least one active ingredient or mixtures thereof in their acid form;

between about 5% and about 70% of at least one non-ionic surfactant;

between 0% and about 50% of at least one anionic surfactant, wherein the term 0% means that the anionic surfactant will not be present in the formulation and the absence of the anionic surfactant is for one of the active ingredients, namely the 2,4-D dichlorophenoxyacetic acid;

between about 5% and about 50% of a polar cosolvent, and

between about 5% and about 30% of water, with all the percentages being expressed in w/v.

As an example of the inventive composition in the event of using 3,6-dichloro-2-metoxibenzoic acid (Dicamba) as active ingredient, the compound preferably comprises about 20.00% of such acid, about 45.00% of at least one ethoxylated fatty alcohol or other non-ionic surfactant; about 2.00% of calcium dodecylbenzenesulfonate or other anionic surfactant; about 25.00% of methanol or other polar solvent, and about 11.00% of water. The surfactans for Dicamba acid may also comprise calcium phenyl sulfonate and/or polyglycolic eters, more preferably a C12-C14 fatty alcohol polyglycolic eter ethoxilated with 7 EO, commercially available under the tradename Genapol C070.

For example, for 1 litre the following formulation may be prepared:

| | |
|---|---|
| Dicamba acid 100% | 200 gr |
| Genapol C070 | 450 gr |
| Methanol | 260 gr |
| Calcium Phenyl Sulfonate | 20 gr |
| Water | 110 gr |

In the event that the 2,4-D dichlorophenoxyacetic acid should be used as active ingredient, the inventive formulation preferably comprises about 30% of the mentioned acid; about 37.00% of at least one non-ionic surfactant which is an ethoxylated fatty amine commercially available under the tradename Genamin T 150; about 7.00-8.00% of at least one non-ionic surfactant which is Tristyrylphenol ethoxylate commercially available under the tradename Emulsogen TS 200; about 8.00% of fatty acids amide, commercially available under the tradename Genagen 4296, employed as an anti-crystallization agent, about 20.00% of a polar cosolvent, which is preferably a mixture of about 50% of ketone and 50% of cyclohexanone, and about 7-11% of water used also as a cosolvent, with the percentages given in w/v.

For example, for 1 litre the following formulation may be prepared:

| | |
|---|---|
| 24D acid 100% | 300 gr |
| Ketone | 104 gr |
| Cyclohexanone | 104 gr |
| Genagen 4296 | 80 gr |
| Genamin T150 | 373 gr |
| Emulsogen TS 200 | 72 gr |
| Water | 110 gr |

According to another aspect of the invention, the compositions may be diluted in water to form a spraying product which is the final product that is prepared, for example in situ, by the farmer in order to feed the product into a spraying machine. When de composition of the invention is based on 2,4-D dichlorophenoxyacetic acid, the spraying phytosanitary product preferably comprises between about 0.5% and 1.0% liters of the composition per 100 liters of water. Alternatively, when de composition of the invention is based on 3,6-dichloro-2-metoxibenzoic acid, the spraying phytosanitary product preferably comprises between about 0.1% and 0.5% liters of the composition per 100 liters of water.

As compared to compositions that are commercially available, the microemulsions of the present invention are stable, not only in the shelf commercial presentation but also in the final sprayable microemulsion, at cold and warm temperatures, thus satisfying the CIPAC/Fao standards. That is, the product must keep the physic and chemical properties in tests for 15 days at 54° C.+/−2C and for 7 days at 0° C.+/−2° C. In addition, the microemulsion of the invention is transparent according to the Tyndall effect.

Compositions of this invention have been subject to field tests with excellent results. As a way of example, the results of one of such tests are transcribed below.

Comparative Tests of Herbicide Compositions of the Invention—Campaign 2009/10

These tests have been carried out by the Agricultural Experimental Station Santiago de Estero from the National Institute of Agricultural Technology.

Product to be assessed: Invention 30% 2,4-D in acid form w/v.

For treating fallow lands and crops of grass, for controlling broadleaf plants.

Deign of tests: Lots of 5 meters x 8 meters with three repetitions.

Treatments discussed:

| N^{o} | Treatment | Blend composition |
|---|---|---|
| 1 | Absolute control plot | — |
| 2 | 2,4-D amine salt (1 lt/ha) | 2,4-D amine salt 60% as salt |
| | | (50% as acid) w/v |
| 3 | 30% 24D in the acid form | 2,4-D acid 30% w/v |
| | (0.7 lt/ha) Doses 1 | |
| 4 | 30% 24D in the acid form | 2,4-D acid 30% w/v |
| | (1.0 lt/ha). Doses 2 | |
| 5 | 30% 24D in the acid form | 2,4-D acid 30% w/v |
| | (1.7 lt/ha). Doses 3 | |

Work Report.

a. Crop: soil without implanted crop, coming from cotton crop in previous campaign, with 5 years of low irrigation, conventional agriculture. Without treatments of weeds prior to the test.

b. Site: Experimental Station La Maria, located on National Road N° 9 Km. 1108, locality of La Abrita, Capital Department, Santiago del Estero.

c. Humidity of soil: the test site received 1 irrigation per stratum before being carrying out thereof. Due to which it was full of abundant humidity and population of weeds.

d. Application features: it was performed on Apr. 7, 2010 at 17 hours, with 25° C. and 70% humidity. It was performed with a Jacto bag and a plane fanned 4-spout bar. A flow equivalent to 130 liters per hectare was used for covering each lot.

e. Weed monitoring: the weed report was performed going over the lot of 40 meters x 60 meters, walking in an X form previous to the test performance. Weeds were recorded using a one-square meter marker in five sampling points within the lot.

In each sampling unit, at the time of application, the species present therein were identified and quantified:

Abundance: Poor: 1-2 individuals.
Not much abundant: 3-6 individuals.
Abundant: more than 6 individuals per sampling unit.

State: Young/Adult.

Frequency: Number of samples in which specie is found/total number of samples.

13 days after sampling and application, the percentage of survival of each species and the percentage of damage on the remaining plant structures were recorded.

f. Result of initial rise:

| | | Abundance | | Frequency of |
|---|---|---|---|---|
| Specie present | | (Average/sample) | State | occurrence |
| 1. | Chenopodium album | Not much | Young | 5/5 |
| | | abundant | | |
| 2. | Glandularia ssp | Abundant | Young | 5/5 |
| 3. | Sonchus oleraceus | Not much | young | 3/5 |
| | | abundant | | |
| 4. | Portulaca oler\acute{a}cea | Not much | Young | 4/5 |
| | | abundant | | |
| 5. | Tagetes minuta | Poor | Adult | 4/5 |
| 6. | Flaveria bidentis | Poor | Young | 3/5 |
| 7. | Amarantus quitensis | Poor | Adult | 4/5 |
| 8. | Coronopus didimus | Poor | Young | 3/5 |
| 9. | Modiolastrum sp. | Abundant | Young | 3/5 |
| 10. | Physalis sp | Poor | Young | 4/5 |

g. Assessment 20 days after application.

| | SPECIE | | | | | | | | | | | | | | | |
|---|---|---|---|---|---|---|---|---|---|---|---|---|---|---|---|---|
| | CH.A. | | G. SSP | | S.O. | | P.O. | | T.M. | | F.B. | | A.Q. | | C.D. | |
| Parameter | S | DR | S | DR | S | DR | S | DR | S | DR | S | DR | S | DR | S | DR |
| Absolute | 100 | 0 | 100 | 0 | 100 | 0 | 100 | 0 | 100 | 0 | 100 | 0 | 100 | 0 | 100 | 0 |
| control | | | | | | | | | | | | | | | | |
| plot | | | | | | | | | | | | | | | | |
| 2,4-D | 40 | 3 | 50 | 4 | 20 | 3 | 20 | 5 | 60 | 3 | 0 | — | 0 | — | 0 | — |
| amine salt | | | | | | | | | | | | | | | | |
| 1 lt/ha | | | | | | | | | | | | | | | | |
| 30% 2,4-D | 10 | 5 | 60 | 3 | 50 | 2 | 20 | 5 | 30 | 5 | 0 | — | 0 | — | 0 | — |
| acid 0.7 lt/ha | | | | | | | | | | | | | | | | |
| 30% 2,4-D | 10 | 5 | 60 | 3 | 0 | — | 20 | 5 | 20 | 5 | 0 | — | 0 | — | 0 | — |
| acid 1 lt/ha | | | | | | | | | | | | | | | | |
| 230% 2,4- | 0 | — | 50 | 3 | 0 | — | 10 | 5 | 20 | 5 | 0 | — | 0 | — | 0 | — |
| D acid | | | | | | | | | | | | | | | | |
| 1.7 lt/ha | | | | | | | | | | | | | | | | |

S: percentage of individuals surviving after the application of each reported species, average of each repetition.

DR: Damage to remaining plant structures, treated weeds and control plot after 20 days post-application, average of each repetition. Scale amounting to 0 (without damage) to 5 (live weed but without healthy remaining structures).

Invention: 2,4-D Acid.

Statistical Analysis

### Variance Analysis

| Variable | N | R² | R² Aj | CV |
|---|---|---|---|---|
| Chenopodium | 15 | 0.89 | 0.81 | 41.04 |

Table of variance analysis (SC type III)

| F.V. | SC | gl | CM | F | p-value |
|---|---|---|---|---|---|
| Model | 49.60 | 6 | 8.27 | 10.78 | 0.0018 |
| Treatments | 49.07 | 4 | 12.27 | 16.00 | 0.0007 |
| Block | 0.53 | 2 | 0.27 | 0.35 | 0.7164 |
| Error | 6.13 | 8 | 0.77 | | |
| Total | 55.73 | 14 | | | |

Test: LSD Fisher Alfa=0.05 DMS=1.64861
Error: 0.7667 gl: 8

| Treatments | Mean | n | | | |
|---|---|---|---|---|---|
| 30% 2,4-D acid 1.7 lts | 0.00 | 3 | A | | |
| 30% 2,4-D acid 1.0 lts | 1.33 | 3 | A | B | |
| 30% 2,4-D acid 0.7 lts | 1.33 | 3 | A | B | |
| 2,4-D amine salt 1.0 lts | 2.67 | 3 | | B | |
| Control plot | 5.33 | 3 | | | C |

Different letters indicate significant differences (p<=0.05)
Var 1. Results for young Chenopodium Album, number of surviving individuals post-treatment (average absolute values of three repetitions).

### Variance Analysis

| Variable | N | R² | R² Aj | CV |
|---|---|---|---|---|
| Glandularia | 15 | 0.79 | 0.64 | 16.69 |

Table of variance analysis (SC type III)

| F.V. | SC | gl | CM | F | p-value |
|---|---|---|---|---|---|
| Model | 3440.00 | 6 | 573.33 | 5.13 | 0.0189 |
| Treatments | 3266.67 | 4 | 816.67 | 7.31 | 0.0088 |
| Block | 173.33 | 2 | 86.67 | 0.78 | 0.4920 |
| Error | 893.33 | 8 | 111.67 | | |
| Total | 4333.33 | 14 | | | |

Test:LSD Fisher Alfa=0.05 DMS=19.89647
Error: 111.6667 gl: 8

| Treatments | Mean | n | |
|---|---|---|---|
| 2,4-D amine salt 1.0 lts | 50.00 | 3 | A |
| 30% 2,4-D acid 1.7 lts | 50.00 | 3 | A |
| 30% 2,4-D acid 1.0 lts | 60.00 | 3 | A |
| 30% 2,4-D acid 0.7 lts | 66.67 | 3 | A |
| Control plot | 90.00 | 3 | B |

Different letters indicate significant differences (p<=0.05)
Var 2. Results for young Glandularia ssp., number of surviving individuals post-treatment (average absolute values of three repetitions).

### Variance Analysis

| Variable | N | R² | R² Aj | CV |
|---|---|---|---|---|
| Sonchus | 15 | 0.88 | 0.79 | 54.77 |

Table of Variance analysis (SC type III)

| F.V. | SC | gl | CM | F | p-value |
|---|---|---|---|---|---|
| Model | 17.60 | 6 | 2.93 | 9.78 | 0.0025 |
| Treatments | 16.00 | 4 | 4.00 | 13.33 | 0.0013 |
| Block | 1.60 | 2 | 0.80 | 2.67 | 0.1296 |
| Error | 2.40 | 8 | 0.30 | | |
| Total | 20.00 | 14 | | | |

Test:LSD Fisher Alfa=0.05 DMS=1.03128
Error: 0.3000 gl: 8

| Treatments | Mean | n | | | |
|---|---|---|---|---|---|
| 30% 2,4-D acid 1.0 lts | 0.00 | 3 | A | | |
| 30% 2,4-D acid 1.7 lts | 0.00 | 3 | A | | |
| 2,4-D amine salt 1.0 lts | 0.67 | 3 | A | B | |
| 30% 2,4-D acid 0.7 lts | 1.67 | 3 | | B | C |
| Control plot | 2.67 | 3 | | | C |

Different letters indicate significant differences (p<=0.05)
Var 3. Results for young Sonchus oleraceus, number of surviving individuals post-treatment (average absolute values of three repetitions).

### Variance Analysis

| Variable | N | R² | R² Aj | CV |
|---|---|---|---|---|
| Portulaca | 15 | 0.74 | 0.54 | 90.62 |

Table of Variance analysis (SC type III)

| F.V. | SC | gl | CM | F | p-value |
|---|---|---|---|---|---|
| Model | 39.60 | 6 | 6.60 | 3.74 | 0.0449 |
| Treatments | 39.07 | 4 | 9.77 | 5.53 | 0.0196 |
| Block | 0.53 | 2 | 0.27 | 0.15 | 0.8623 |
| Error | 14.13 | 8 | 1.77 | | |
| Total | 53.73 | 14 | | | |

Test:LSD Fisher Alfa=0.05 DMS=2.50260
Error: 1.7667 gl: 8

| Treatments | Mean | n | | |
|---|---|---|---|---|
| 30% 2,4-D acid 1.7 lts | 0.33 | 3 | A | |
| 2,4-D amine salt 1.0 lts | 0.67 | 3 | A | |
| 30% 2,4-D acid 1.0 lts | 0.67 | 3 | A | |
| 30% 2,4-D acid 0.7 lts | 1.00 | 3 | A | |
| Control plot | 4.67 | 3 | | B |

Different letters indicate significant differences (p<=0.05)
Var 4. Results for young Portulaca oleracea, number of surviving individuals post-treatment (average absolute values of three repetitions).

### Variance Analysis

| Variable | N | R² | R² Aj | CV |
|---|---|---|---|---|
| Tagetes | 16 | 0.82 | 0.70 | 40.90 |

Table of Variance analysis (SC type III)

| F.V. | SC | gl | CM | F | p-value |
|---|---|---|---|---|---|
| Model | 17.77 | 6 | 2.96 | 6.71 | 0.0062 |
| Treatments | 17.26 | 4 | 4.31 | 9.77 | 0.0025 |
| Block | 0.11 | 2 | 0.05 | 0.12 | 0.8868 |
| Error | 3.98 | 9 | 0.44 | | |
| Total | 21.75 | 15 | | | |

Test:LSD Fisher Alfa=0.05 DMS=1.19281
Error: 0.4418 gl: 9

| Treatments | Mean | n | | | |
|---|---|---|---|---|---|
| 30% 2,4-D acid 1.0 lts | 0.67 | 3 | A | | |
| 30% 2,4-D acid 1.7 lts | 0.67 | 3 | A | | |
| 30% 2,4-D acid 0.7 lts | 1.00 | 3 | A | B | |
| 2,4-D amine salt 1.0 lts | 2.00 | 3 | | B | |
| Control plot | 3.24 | 4 | | | C |

Different letters indicate significant differences (p<=0.05)
Var 5. Results for adult Tagetes minuta, number of surviving individuals post-treatment (average absolute values of three repetitions).

### Variance Analysis

| Variable | N | R² | R² Aj | CV |
|---|---|---|---|---|
| Flaveria | 16 | 0.77 | 0.62 | 128.81 |

Table of Variance analysis (SC type III)

| F.V. | SC | gl | CM | F | p-value |
|---|---|---|---|---|---|
| Model | 28.60 | 6 | 4.77 | 5.11 | 0.0150 |
| Treatments | 26.40 | 4 | 6.60 | 7.07 | 0.0074 |
| Block | 1.60 | 2 | 0.80 | 0.86 | 0.4563 |
| Error | 8.40 | 9 | 0.93 | | |
| Total | 37.00 | 15 | | | |

Test:LSD Fisher Alfa=0.05 DMS=1.73381
Error: 0.9333 gl: 9

| Treatments | Mean | n | | |
|---|---|---|---|---|
| 30% 2,4-D acid 1.7 lts | 0.00 | 3 | A | |
| 30% 2,4-D acid 0.7 lts | 0.00 | 3 | A | |
| 2,4-D amine salt 1.0 lts | 0.00 | 3 | A | |
| 30% 2,4-D acid 1.0 lts | 0.00 | 3 | A | |
| Control plot | 3.00 | 4 | | B |

Different letters indicate significant differences (p<=0.05)
Var 6. Results for young Flaveria bidentis, number of surviving individuals post-treatment (average absolute values of three repetitions).

### Variance Analysis

| Variable | N | R² | R² Aj | CV |
|---|---|---|---|---|
| Amarantus | 16 | 0.77 | 0.61 | 128.22 |

Table of Variance analysis (SC type III)

| F.V. | SC | gl | CM | F | p-value |
|---|---|---|---|---|---|
| Model | 15.26 | 6 | 2.54 | 4.89 | 0.0172 |
| Treatments | 14.55 | 4 | 3.64 | 6.99 | 0.0076 |
| Block | 0.07 | 2 | 0.03 | 0.07 | 0.9370 |
| Error | 4.68 | 9 | 0.52 | | |
| Total | 19.94 | 15 | | | |

Test:LSD Fisher Alfa=0.05 DMS=1.29440
Error: 0.5202 gl: 9

| Treatments | Mean | n | | |
|---|---|---|---|---|
| 30% 2,4-D acid 1.7 lts | 0.00 | 3 | A | |
| 30% 2,4-D acid 0.7 lts | 0.00 | 3 | A | |
| 2,4-D amine salt 1.0 lts | 0.00 | 3 | A | |
| 30% 2,4-D acid 1.0 lts | 0.00 | 3 | A | |
| Control plot | 2.23 | 4 | | B |

Different letters indicate significant differences (p<=0.05)
Var 7. Results for adult Amarantus quitensis, number of surviving individuals post-treatment (average absolute values of three repetitions).

### Variance Analysis

| Variable | N | R² | R² Aj | CV |
|---|---|---|---|---|
| Coronopus | 16 | 0.82 | 0.71 | 109.18 |

Table of Variance analysis (SC type III)

| F.V. | SC | gl | CM | F | p-value |
|---|---|---|---|---|---|
| Model | 33.36 | 6 | 5.56 | 7.07 | 0.0052 |
| Treatments | 30.55 | 4 | 7.64 | 9.71 | 0.0025 |
| Block | 1.67 | 2 | 0.83 | 1.06 | 0.3860 |
| Error | 7.08 | 9 | 0.79 | | |
| Total | 40.44 | 15 | | | |

Test:LSD Fisher Alfa=0.05 DMS=1.59197
Error: 0.7869 gl: 9

| Treatments | Mean | n | | |
|---|---|---|---|---|
| 2,4-D amine salt 1.0 lts | 0.00 | 3 | A | |
| 30% 2,4-D acid 1.0 lts | 0.00 | 3 | A | |
| 30% 2,4-D acid 0.7 lts | 0.00 | 3 | A | |
| 30% 2,4-D acid 1.7 lts | 0.00 | 3 | A | |
| Control plot | 3.23 | 4 | | B |

Different letters indicate significant differences (p<=0.05)
Var 8. Results for young Coronopus didimus, number of surviving individuals post-treatment (average absolute values of three repetitions).

### Variance Analysis

| Variable | N | R² | R² Aj | CV |
|---|---|---|---|---|
| Modiolastrum | 16 | 0.65 | 0.42 | 188.84 |

Table of Variance analysis (SC type III)

| F.V. | SC | gl | CM | F | p-value |
|---|---|---|---|---|---|
| Model | 371.42 | 6 | 61.90 | 2.78 | 0.0818 |
| Treatments | 337.55 | 4 | 84.39 | 3.79 | 0.0450 |
| Block | 71.42 | 2 | 35.71 | 1.60 | 0.2540 |
| Error | 200.58 | 9 | 22.29 | | |
| Total | 572.00 | 15 | | | |

Test:LSD Fisher Alfa=0.05 DMS=8.47242
Error: 22.2869 gl: 9

| Treatments | Mean | n | | |
|---|---|---|---|---|
| 2,4-D amine salt 1.0 lts | 0.00 | 3 | A | |
| 30% 2,4-D acid 1.0 lts | 0.00 | 3 | A | |
| 30% 2,4-D acid 0.7 lts | 0.00 | 3 | A | |
| 30% 2,4-D acid 1.7 lts | 0.00 | 3 | A | |
| Control plot | 10.73 | 4 | | B |

Different letters indicate significant differences (p<=0.05)
Var 9. Results for young Modiolastrum ssp, number of surviving individuals post-treatment (average absolute values of three repetitions).

### Variance Analysis

| Variable | N | R² | R² Aj | CV |
|---|---|---|---|---|
| Physalis | 16 | 0.31 | 0.00 | 69.21 |

Table of Variance analysis (SC type III)

| F.V. | SC | gl | CM | F | p-value |
|---|---|---|---|---|---|
| Model | 6.28 | 6 | 1.05 | 0.66 | 0.6809 |
| Treatments | 2.77 | 4 | 0.69 | 0.44 | 0.7768 |
| Block | 2.84 | 2 | 1.42 | 0.90 | 0.4394 |
| Error | 14.16 | 9 | 1.57 | | |
| Total | 20.44 | 15 | | | |

Test:LSD Fisher Alfa=0.05 DMS=2.25114
Error: 1.5734 gl: 9

| Treatments | Mean | n | |
|---|---|---|---|
| 30% 2,4-D acid 0.7 lts | 1.33 | 3 | A |
| 2.4-D amine salt 1.0 lts | 1.33 | 3 | A |
| 30% 2.4-D acid 1.0 lts | 1.67 | 3 | A |
| 30% 2.4-D acid 1.7 lts | 2.00 | 3 | A |
| Control plot | 2.38 | 4 | A |

Different letters indicate significant differences (p<=0 05)
Var 10. Results for young Physalis ssp, number of surviving individuals post-treatment (average absolute values of three repetitions).

Final Comments

Good conditions of humidity and temperature benefited the action of 2,4-D in all the lots for this test.

The doses of 0.7 lt/ha of the acid formulation 30% w/v had an acceptable control over assessed weeds, and it is highlighted that it was lower than control of 1 lt/ha of amine salt and slower.

On the other hand, when increasing the doses of the assessed product to 1 lt/ha, it broadly surpassed the control plot product in the same doses not only with regard to rate of action, but also it had a more evident and severe deforming effect much on weeds. This effect was even more enhanced in the case of doses amounting to 1.7 lt/ha, which was clearly differentiated from the rest of treatments both with regard to deforming severity and rate of action.

Due to the slow action of the assessed products, observation was performed on 12, 20 and 28 days after the application with the aim of being able to assess the test results at their maximum expression and record the plant death or otherwise. However, deforming symptoms began to be noted on plants few days after applications.

1. Phytosanitary compositions in the form of microemulsions with active ingredients formulated in their acid form in order not to alter the activity of such active ingredients, the compositions comprising:
between 2% and 40% of at least one active ingredient or mixtures thereof in their acid form;
between about 5% and about 70% of at least one non-ionic surfactant;
between 0% and about 50% of at least one anionic surfactant;
between about 5% and about 50% of an organic solvent, and
between about 5% and about 30% of water, with all the percentages being expressed in w/v,
wherein the active ingredient and the organic solvent provide a lipophilic part of the microemulsion, and a hydrophilic part of the microemulsion comprises water.

2. Compositions according to claim 1, wherein said at least one non-ionic surfactant is selected from the group consisting of ethoxylated fatty alcohol, ethoxylated fatty amines, and tristyrylphenol ethoxylated, and said at least one anionic surfactant is calcium dodecylbenzenesulfonate.

3. Compositions according to claim 1, wherein said at least one active ingredient is selected from the group consisting of 2,4-D(2,4 dichlorophenoxyacetic acid (24D) and 3,6-dichloro-2-methoxybenzoic acid (Dicamba).

4. Compositions according to claim 2, wherein said at least one active ingredient is selected from the group consisting of 2,4-D(2,4 dichlorophenoxyacetic acid (24D) and 3,6-dichloro-2-methoxybenzoic acid (Dicamba).

5. Compositions according to claim 1, wherein said solvent is selected from the group consisting of methyl alcohol, ketone and cyclohexanone.

6. Compositions according to claim 2, wherein said solvent is is selected from the group consisting of methyl alcohol, ketone and cyclohexanone.

7. Compositions according to claim 1, comprising:
about 26.00% of said at least one active ingredient, which is 100% technical grade 24D acid, or mixtures thereof;
about 33.00% of said at least one non-ionic surfactant which is an ethoxylated fatty amine;
about 7.00% of said at least one non-ionic surfactant which is Tristyrylphenol ethoxylate.
about 7.00% of a fatty acid amide,
about 18.00% of said solvent, which is a mixture of about 50% of ketone and 50% of cyclohexanone, and
9.00% of water.

8. Compositions according to claim 1, comprising:
20.00% of said at least one active ingredient, which is 100% technical grade Dicamba acid;
about 44.00% of said least one non-ionic surfactant which is at least one ethoxylated fatty alcohol;
about 2.00% of said at least one anionic surfactant which is calcium dodecylbenzenesulfonate;
about 24.00% of said solvent which is methanol, and
about 10.00% of water.

9. A spraying phytosanitary product comprising between about 0.5 and 1.0 liters of the composition of claim 7 per 100 liters of water.

10. A spraying phytosanitary product comprising between about 0.1 and 0.5 liters of the composition of claim 8 per 100 liters of water.
